(19) United States
(12) Patent Application Publication
(10) Pub. No.: US 2026/0094466 A1
(43) Pub. Date: Apr. 2, 2026

(54) SYSTEM AND METHOD FOR PREDICTING A PREFERENCE FOR FITTING IN-EAR HEADPHONE(S)

(71) Applicant: HARMAN INTERNATIONAL INDUSTRIES, INCORPORATED, Stamford, CT (US)

(72) Inventors: Harikrishna MURALIDHARA, Bangalore, Karnataka (IN); Yadati Naga PRAMOD, Bangalore (IN); Ravi Shanker GUPTA, Bangalore, Karnataka (IN); Kadagattur Gopinatha SRINIDHI, Novi, MI (US); BongJin SOHN, West Bloomfield, MI (US)

(73) Assignee: HARMAN INTERNATIONAL INDUSTRIES, INCORPORATED, Stamford, CT (US)

(21) Appl. No.: 19/109,033

(22) PCT Filed: Sep. 6, 2023
(86) PCT No.: PCT/US2023/032057

§ 371 Date: Mar. 5, 2025

(30) Foreign Application Priority Data
Sep. 6, 2022 (IN) 202241050800

(51) Int. Cl. G06V 40/10; G06Q 30/0601; G06V 10/25; G06V 10/26; G06V 10/32; G06V 10/40; G06V 10/77; G06V 20/40

(52) U.S. Cl. CPC G06V 40/10; G06Q 30/06431; G06V 10/25; G06V 10/26; G06V 10/32; G06V 10/40; G06V 10/77; G06V 20/40

(57) ABSTRACT

In at least one embodiment, a system for predicting a user's fit preference for an in-ear headphone is provided. The system includes an image detection device and at least one controller. The image detection device is programmed to capture at least one image of a user's ear. The at least one controller is programmed to detect one or more anatomical features on the least one image of the user's ear and to provide at least one selected in-ear headphone to the user based at least on the one or more anatomical features.

### CROSS-REFERENCE TO RELATED APPLICATIONS

This application claims priority to IN application No. 202241050800 filed Sep. 6, 2022, the disclosure of which is hereby incorporated in its entirety by reference herein.

### TECHNICAL FIELD

The present invention generally relates to in-ear headphone(s), and more particularly to predicting a user's fit preference for an in-ear headphone.

### BACKGROUND

True Wireless Stereo (TWS) devices including in-ear headphones (or earbuds) are increasingly becoming a popular method of rendering music and speech to end consumers. The earbuds are compact and come in various shapes and form factors. Ear anatomy plays a large role in defining a consumer's preference for earbuds. Currently, there is no method to resolve assessing an end user's feel for the comfort of the earbud other than trying the earbuds on. The inventive subject matter addresses this limitation, and others, with an image-based algorithm to predict preferences.

### SUMMARY

The disclosed system and method may provide, but is not limited to, a listing of types of in-ear headphone(s) or earbud(s) that are deemed most suitable for a user. These aspects and other will be described in more detail below.

In at least one embodiment, a system for predicting a user's fit preference for an in-ear headphone is provided. The system includes an image detection device and at least one controller. The image detection device is programmed to capture at least one image of a user's ear. The at least one controller is programmed to detect one or more anatomical features on the least one image of the user's ear and to provide at least one selected in-ear headphone to the user based at least on the one or more anatomical features.

In at least another embodiment, a method for predicting a user's fit preference for an in-ear headphone. The method includes receiving at least one image of a user's ear and detecting one or more anatomical features on the least one image of the user's ear. The method further includes providing at least one selected in-ear headphone to the user based at least on the one or more anatomical features.

In at least another embodiment, a computer-program product embodied in a non-transitory computer read-able medium that is executable by at least one controller to predict a user's fit preference for an in-ear headphone is provided. The computer-program product comprising instructions for receiving at least one image of a user's ear and detecting one or more anatomical features on the least one image of the user's ear. The method comprises providing at least one selected in-ear headphone to the user based at least on the one or more anatomical features.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIGS. 1A-1F generally depict examples of various earbuds that exhibit different shapes and sizes;

FIG. 2 generally depicts a plurality of human ears each having different characteristics from one another;

FIG. 3 generally depicts a system for predicting a preference for fitting in-ear headphone(s) or earbuds in accordance with one embodiment;

FIG. 4 depicts a user's ear and corresponding an ear plane in accordance with one embodiment;

FIG. 5 generally depicts a method for predicting the preference for fitting in-ear headphone(s) or earbuds in accordance with one embodiment;

FIG. 6 generally depicts a more detailed block diagram of a blur and distortion filter in accordance with one embodiment in accordance with one embodiment.

FIG. 7 depicts a screen shot illustrating instructions for performing video capture in accordance with one embodiment;

FIG. 8 depicts another screen shot providing a prompt to initiate recording in accordance with one embodiment;

FIG. 9 depicts another screen shot illustrating a video capture of a user's right ear in accordance with one embodiment;

FIG. 10 depicts another screen shot illustrating a video capture of a user's left ear in accordance with one embodiment;

FIG. 11 depicts another screen shot illustrating recommended in-ear headphones to the user in accordance with one embodiment;

FIG. 12 depicts another screen shot illustrating various in-ear headphones assessed in connection with the user's ear measurements in accordance with one embodiment; and

FIG. 13 depicts another screen shot illustrating a user feedback screen in accordance with one embodiment.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” and/or “at least one” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including.” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event].” depending on the context

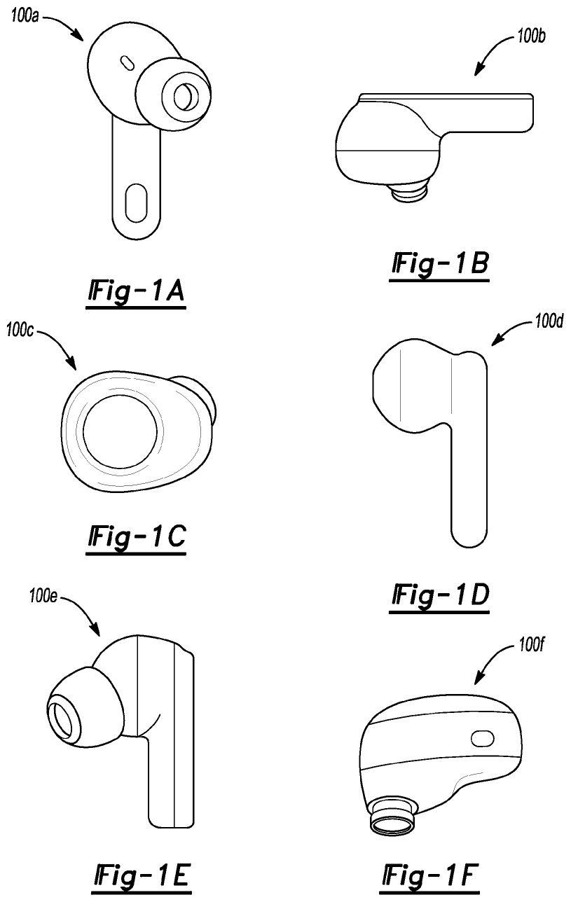

FIGS. 1A-1F generally depict examples of various earbuds 100a-100f, respectively, that exhibit different characteristics. The various earbuds 100a-100f exhibit different characteristics such as size, shape, and material that may impact the overall comfort for a user when any one of the earbuds 100a-100f are inserted into a user's ears. In general, the earbuds 100a-100f corresponds to various examples of earbuds having varying shapes and form factors. It is recognized that the embodiment(s) disclosed herein may recommend a specific earbud of any of the corresponding earbuds 100a-100f. In addition, the embodiment(s) disclosed herein may provide recommend an earbud 100a-100f having a specific form factor such as an earbud like a TWS device that is completely in the ear such as, but not limited to, earbud 100c.

The user may have various preferences in terms of traits that are desirable when the earbuds are worn. Such preferences may include, for example, the ability for the earbud to remain in the ear canal for long periods of time, particularly, in moments in which the user may engage in a workout and perspire. Similarly, the user preference may include wearing the earbuds comfortably for longer periods of time. In many cases, the overall size and/or material of any one of the earbuds 100a-100f that is inserted into an ear canal and that abuts a concha of the user's ear dictates the user's level of comfort. In addition, the overall size and/or material of any one of the earbuds 100a-100f dictate the manner in which the earbud 100a-100f can remain fixed in the ear, particularly, in moments in which the user perspires during a workout or other activity. Additional non limiting preferences may also include fit, for example, that the earbud is not painful while seated in the user's ear and at the same time. As noted above, it is preferable that the earbud is not too loose thereby lacking stability. A lack of a good fit may also have a negative impact on the acoustic experience of the wearer.

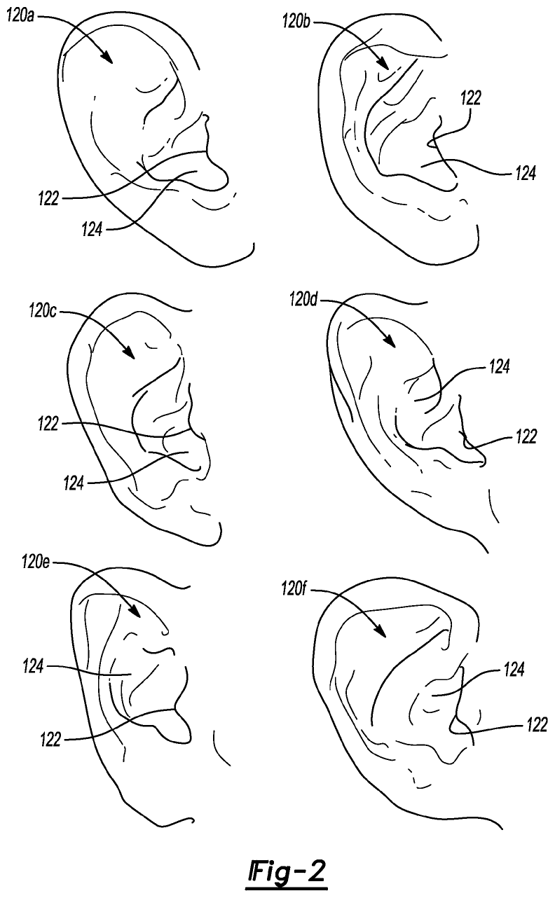

FIG. 2 generally depicts a plurality of human ears 120a-120f each having different characteristics or variations from one another. In general, one or more of the earbuds 100a-100f may be inserted into various ear canals 122a-122f, of the ears 120a-120f. The overall size and/or shape of the ear canals 122 (or size of the openings defined by walls of the ear canals 122) for the various ears 120a-120f may vary from user to user. Similarly, each ear 120a-120f defines a concha 124 which includes a depression positioned in an inner ear that leads to an initial opening of the ear canal 122. The size and shape of the concha 124 may also vary from user to user. The manner in which any one of the earbuds 100a-100f fits or resides in the concha 124 may also affect user comfort when any one of the earbuds 100a-100f are inserted into any of the ears 120a-120f. As can be readily seen, each earbud 100a-100f includes various characteristics (e.g., size, shape, and material) that impact user comfort when inserted into a corresponding ear 120a-120f.

As exhibited in light of FIGS. 1 and 2, the overall fit and comfort of any one of the earbuds 100a-100f when inserted into any one of the ears 120a-120f may be dictated by the size, shape, and material of the various earbud 100a-100f and/or the size and shape of the ear canal 122 and/or concha 124. While consumer may have a plethora of choices with respect to the earbuds 100a-100f, the consumers may not have a mechanism to assist in identifying which earbud would be the most appropriate. Thus, the present disclosure provides a system that can recommend, with a high probability, the optimal earbud for their respective ear anatomy that would be the most advantageous with respect to each of their own preferences. Manufacturers of the earbud 100a-100f generally do not allow or would not prefer that users return the earbuds 100a-100f after purchase for sanitary reasons in the event the user is dissatisfied with the feel and fit of the earbud 100a-100f after purchase. Thus, it may be advantegous to develop a system that determines or provides a recommended set of earbuds to a user based on the anatomical aspects of the user's ears and further based on the size, shape, and material of the earbud 100a-100f to provide the optimal fit and comfort for the user before the user purchases a particular earbud 100a-120f.

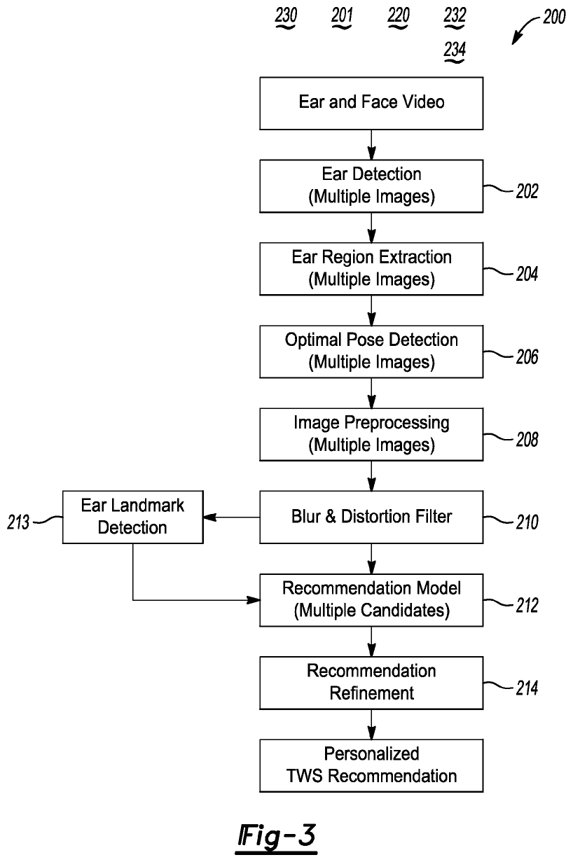

FIG. 3 generally depicts a system 200 for predicting or determining an optimal earbud 100a-100f for the user in accordance with one embodiment. The system 200 generally includes an ear detection block 202, an ear region extraction block 204, a pose detection block 206, an image pre-processing block 208, a blur and distortion filter 210, a recommendation model block 212, an ear landmark detection block 213, and a recommendation refinement block 214. The system 200 may be implemented on an electronic device 201 such as a mobile device, laptop, tablet, or any other device that includes an image detection device (camera) 220 for capturing images of the user's ears 120a-120f. The system 200 includes at least one controller 230 (hereafter “the controller 230”) positioned on the mobile device, laptop, tablet, etc. to perform any one of the noted operations as set forth herein in connection with the system 200. The system 200 may utilize, for example, but not limited to, a Fitchecker algorithm to determine or ascertain the optimal set of earbuds 100a-100f. At least one memory device 232 (hereafter “the memory device 232”) is coupled to the controller 230. At least one camera 234 (hereafter “the camera 234) may be positioned on the electronic device 201 to capture images of object(s) external to the electronic device 201.

The ear detection block 202 receives images of the user's face and ears (i.e., left and right ears) from the camera 234. The ear detection block 202 utilizes a deep learning model to identify an image of the right car and the left car to create a bonding box around the left car and a bounding box around the right ear. In one example, the bonding box generally corresponds to coordinates of a rectangular border that fully encloses a digital image of the left and right ear. The ear region extraction block 204 crops the image outside of the bounding boxes to reduce the processing load in order to work with a smaller image. The pose detection block 206 identifies the best images of the ears (e.g., left and right) as multiple images of the left and right ears may be provided to the system 200. The system 200 selects the best images based on an area of the bounding box and an area of the ear as positioned in the bounding box.

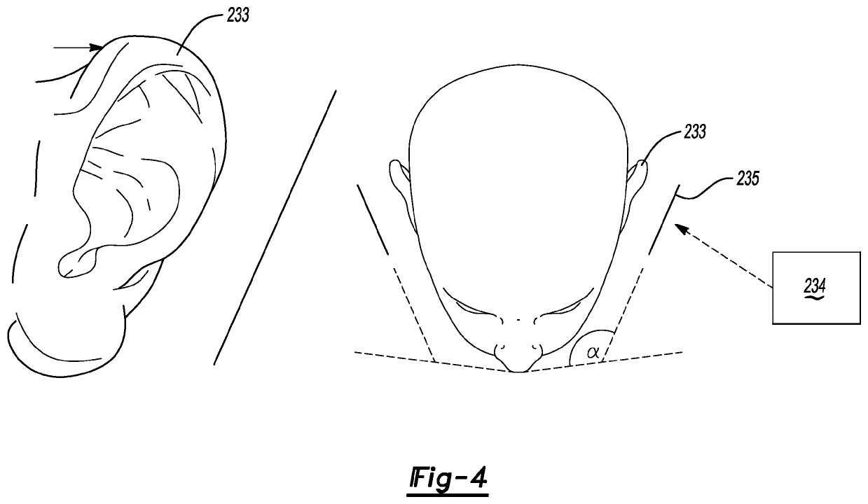

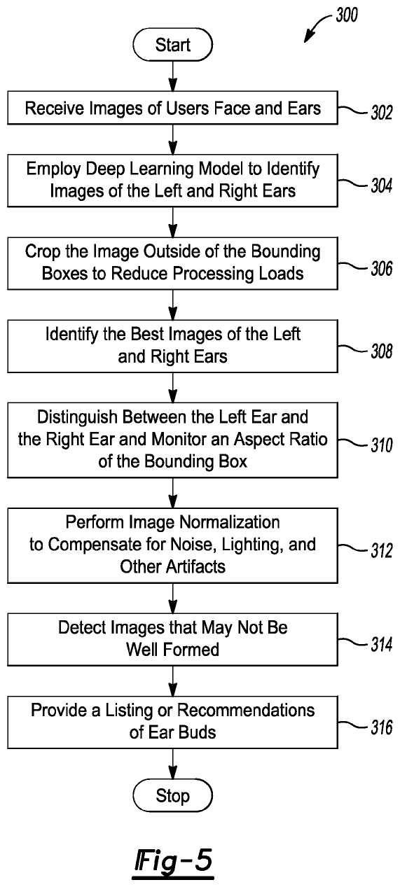

FIG. 4 generally illustrates an anatomy of the user's ear 233 and corresponding profile that yields an optimal image. In general, the best image of the ear 233 generally corresponds to an image that is captured when the camera 234 is positioned in front of the ear 233 and is generally perpendicular to an ear plane 235 of a side of the user's head. In this case, the anatomy of the user's ear 233 is capable of being fully captured and characterized by the controller 230. The ear plane 235 is generally positioned in parallel to the user's ear 233 and positioned axially spaced apart from the ear 233 and forms an angle α relative to a tip of the user's nose as shown in FIG. 4. In general, the angle α may correspond to an angle that is greater than 90 degrees and less than 180 degrees.

Referring back to FIG. 3, the pose detection block 206 distinguishes between the left ear and the right ear and monitors an aspect ratio of the bounding box for the left ear and the bounding box for the right ear. The aspect ratio of the bounding box for the left ear and the bounding box for the right ear may serve as a reliable or advantageous metric to assess the validity of utilizing the given image(s) prior to such images being providing as an input to the recommendation model block 212. The aspect ratio generally corresponds to a ratio of the width to height of an image. As noted above, an image of the ear, taken at an angle, suffers from perspective skew. This could result in the bounding box being either too wide or too long. Thus, in this regard, the aspect ratio of the bounding box that is within acceptable limits (or predetermined limits) of the anatomy of the ear may be considered optimal. Stated differently, an aspect ratio that is in a bounded range is indicative of an acceptable image. Also, consider the case of turning the face of the user from the front to the side where the ear becomes more visible. In this case, the aspect ratio also increases thereby resulting in a peak. Therefore, by monitoring the aspect ratio, the controller 230 may be used to infer (or determine) whether the target person's ear area was captured from the front or the side of the face.

The image pre-processing block 208 performs image normalization to compensate for noise, lighting, and other artifacts that are present in the bounding box of the left ear and the bounding box of the right ear. Image normalization generally includes a process that changes the range of pixel intensity values. For example, the image pre-processing block 208 may perform contrast normalization and brightness correction. A linear normalization of a grayscale digital image is generally defined by the following formula:

$${I}_{N} = ( I - Min ) * ( newMax - newMin ) / ( Max - Min ) + newMin$$

where IN corresponds to a new image having {newMin, . . . , newMax} with intensity values in the range (newMin, newMax).

The blur and distortion filter (or bilateral filter) 210 detects images that may not be well formed either due to camera or subject (or user) motion or video compression related artifacts. In general, images that are not well-formed are not considered. In general, the system 200 looks for candidate images that are in a temporal vicinity of this image with the least blur to identify the preferred image. Since the video is captured by the camera 234 while the user is moving, blurry images may be attributed to motion and may be included as input. Among these images, the model calculates blur amount to select predictable images. Therefore, among the collected inputs, images with less blur effects are selected as inputs, and if this is not possible, the user is requested to retake images. In the context of an algorithm that is executed by the blur and distortion filter 210, such an algorithm reduces image noise based on values of surrounding pixels of the target pixel. Subsequently, a CLAHE algorithm, for example, is also executed by the blur and distortion filter 210 to equalize a histogram. This results in a high-contrast image. Following this, the blur & distortion filter 210 executes an edge detection algorithm on the image and such an algorithm capitalizes on a lack of clarity in edges of blurry images. The blur and distortion filter 210 may then average this value to calculate an overall blur value of the image.

The recommendation model block 212 may be implemented as a deep learning model to provide a listing of recommendations that corresponds to any one or more of the earbuds 100a-100f that may provide optimal fit and comfort based on the shape, size and material of the such earbuds 100a-100f and also based on the anatomical features of the user's ears (e.g., size/shape of ear canal 122 and concha 124, etc.). In general, the inputs provided to the recommendation model block 212 may need to be a clean image (e.g., blur free and/or distortion free image. Thus, in this regards the blur and distortion filter 210 provides such a clean image.

The ear landmark detection block 213 generally detects various anatomical landmark features of the images of the left and right ears of the user. For example, the ear landmark detection block 213 provides an estimation of critical features points that define an ear geometry. Such points (or anatomical points) may include a helix, a superior cris, a triangular fossa, an inferior crus, a concha cymba (or the concha), a tragus, an external auditory canal, a concha cavum (or the concha), a lobule, an antitragus, an antihelix, and/or a scaphoid fossa. The recommendation model block 212 may utilize Conventional Neural Networks (CNN) as the deep learning model. The recommendation model block 212 and its corresponding deep learning model is executed by the controller 230. For example, the controller 230 may execute the recommendation model block 212 for example, once per input image, when multiple images are provided to the recommendation block 212. The recommendation refinement block 214 refines the recommendation output provided by the recommendation model block 212. For example, the recommendation refinement block 214 provides intelligence to refine the different recommendations to provide a final result (or recommended earbud). The system 200 is arranged to enhance accuracy by capturing multiple images of the user's ear area, predict probability values from each image, and combine such images using a soft voting algorithm. For example, the soft voting algorithm may be defined by the following equation:

$$Final {Score}_{i} = \frac{1}{n} {\sum }_{k = 1}^{n} ( Predicted {Score}_{ik} - {Threshold}_{i} ) * \frac{1}{1 - {Threshold}_{i}}$$

The soft voting algorithm in simple terms, generally involves averaging various predictions of multiple images. Other methods such as hard voting (selecting the predicted class with the most frequent top-ranked predictions) are also available. As shown in the equation above, the predicted score may correspond to the predicted probability values from each image as noted above where such values are subtracted by a threshold and divided by the threshold in the manner shown in the equation above. The methods employed by the recommendation refinement block 214 may be changable based on the situation. Therefore, it is recognized that other algorithms may be executable by the recommendation model block 212 that may not involve soft voting alone. For example, the recommendation model block 212 may employ (or execute) a hard voting algorithm in another embodiment.

In general, the controller 230 of the electronic device 201 may be a central processing unit (CPU) such as for example, an Intel/AMD X86 or ARM microprocessor. It is recognized that there may or may not be a need for cloud or wireless access to execute the one or more aspects of the system 200.

FIG. 5 generally depicts a method 300 for providing a recommended set of earbuds 100a-100f in accordance with one embodiment. In operation 302, the controller 230 receives images of the user's face and ears (i.e., left and right ears). In operation 304, the controller 230 utilizes a deep learning model to identify an image of the right ear and the left ear to create a bonding box around the left ear and a bounding box around the right ear. In operation 306, the controller 230 crops the image outside of the bounding boxes to reduce the processing load in order to work with a smaller image.

In operation 308, the controller 230 identifies the best images of the ears (e.g., left and right) as multiple images of the left and right ears may be provided to the system 200. In operation 310, the controller 230 distinguishes between the left ear and the right ear and monitors an aspect ratio of the bounding box for the left ear and the bounding box for the right ear. In operation 312, the controller 230 performs image normalization to compensate for noise, lighting, and other artifacts that are present in the bounding box of the left ear and the bounding box of the right ear.

In operation 314, the controller 230 detects images that may not be well formed either due to camera or subject (or user) motion or video compression related artifacts. In operation 316, the controller 230 provide a listing of recommendations that corresponds to any one or more of the earbuds 100a-100f that may provide optimal fit and comfort based on the shape, size and material of the such earbuds 100a-100f and further based on the anatomical features of the user's ears (e.g., size/shape of ear canal 122 and/o concha 124, etc.)

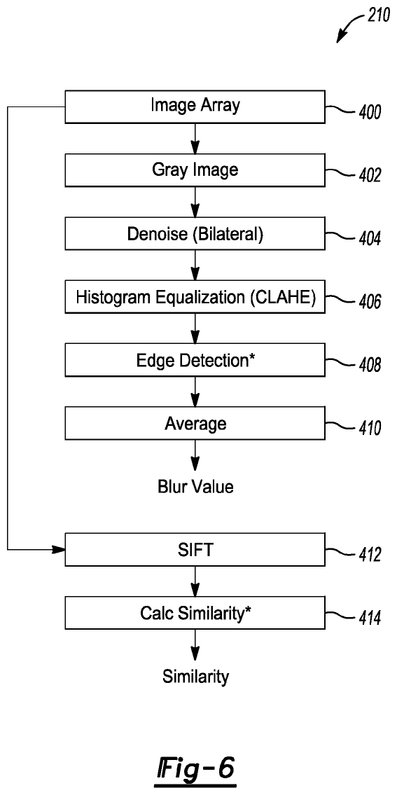

FIG. 6 generally depicts a more detailed block diagram of the blur and distortion filter 210 in accordance with one embodiment. The blur and distortion filter 210 includes an array block 400, a gray image block 402, a denoise block 404, a histogram equalization block 406, an edge detection block 408, an average block 410, a Scale-Invariant Feature Transform (SIFT) block 412 and a calculate similarity block 414. The array block 400 receives the images of the left and right ears in an image array. The gray image block 402 generates a gray image of the images in the array. In one example, the gray image may be a grayscale image in which each pixel that represents the image corresponds to a single sample that represents an amount of light (or intensity information). The denoise block 404 may remove noise from the signal (or the grey image(s). The histogram equalization block 406 may utilize an image processing technique to improve a contrast in the images. The edge detection block 408 may identify edges and/or curves in the digital images received in which image brightness may have changed sharply or formally has discontinuities. The average block 410 enhances video image that may have been corrupted by random noise and provides a blur value. The SIFT block 412 may detect and describe local features in images (e.g., local aspects of the anatomical features of the user's ears 120a-120e. The calculate similarity block 41 may perform at least the following calculations to provide the clean image.

$$* Calc Similarity = \frac{1}{N} {\sum }_{j = 1}^{N} Similarity ( i , j )$$

$$N : Number of images , i \text{:} {i}_{th} image$$

$$Final Score = \{ \begin{matrix}\begin{matrix}{W}_{0} * Norm ( Similarity ) + {W}_{1} * Norm ( Blur Value ) for \\ Similarity \geq {Threshold}_{0} and Blur Value \geq \end{matrix} \\ \begin{matrix}{Threshold}_{1} \\ 0 , Otherwise\end{matrix} \\ Final Rank = Argsort ( Final Score )\end{matrix}$$

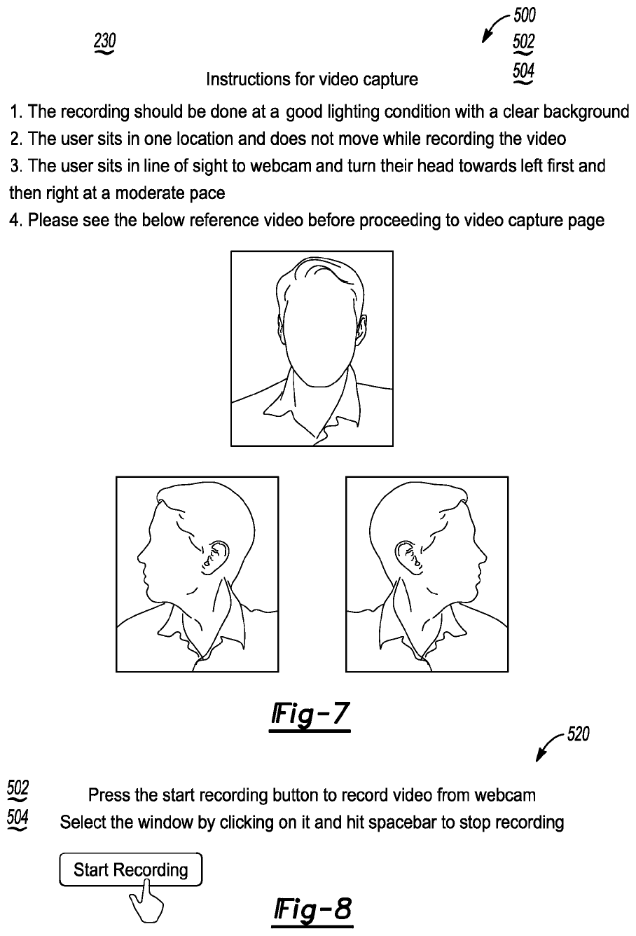

FIG. 7 depicts a screen shot 500 illustrating instructions for performing video capture of the user in accordance with one embodiment. The electronic device 201 generally includes a user interface 502 having a display 504 that provides the screen shot 500 to the user. The user may control the electronic device 201 such that the controller 230 executes instructions to run an application to perform the method 300 as noted in connection FIG. 5. In this case, the display 504 provides instructions to the user to aid in obtaining a video (or image) capture/recording of the user's ears. For example, the display 504 may direct the user to obtain the video recording in an area where adequate lighting is provided and with a clear background. Similarly, the user may be instructed not to move while recording the video. In general, the user may sit in a line of sight relative to the camera 234. The user may turn his/her head to the left or to the right and then to the opposite side at a predetermined rate or pace. The screen shot 500 provides visual examples of the manner in which the user turns his/her to the left and right.

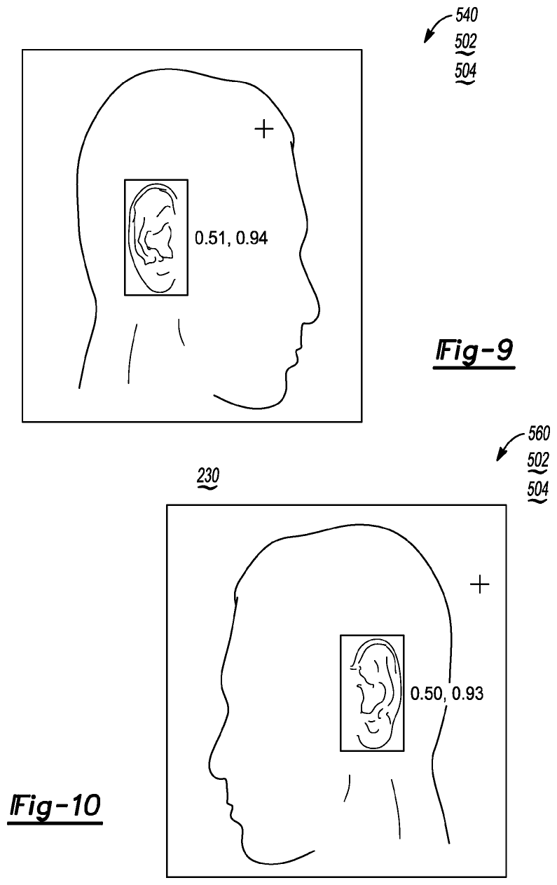

FIG. 8 depicts another screen shot 520 providing a prompt to initiate recording in accordance with one embodiment. The display 504 provides instructions to the user to select a recording button to record the video from the camera 234. FIG. 9 depicts another screen shot 540 illustrating a video capture of a user's right ear on the display 504 of the user interface 502 in accordance with one embodiment. The screen shot 540 illustrates an aspect ratio of the bounding box and a confidence value for that measurement. It is recognized that the screen shot 540 may or may not include the aspect ratio and/or confidence value for the measurement. FIG. 10 depicts another screen shot 560 illustrating a video capture of a left right ear on the display 504 of the user interface 502 in accordance with one embodiment. Similarly, the screen shot 560 illustrates an aspect ratio of the bounding box and a confidence value for that measurement. It is recognized that the screen shot 560 may or may not include the aspect ratio and/or confidence value for the measurement.

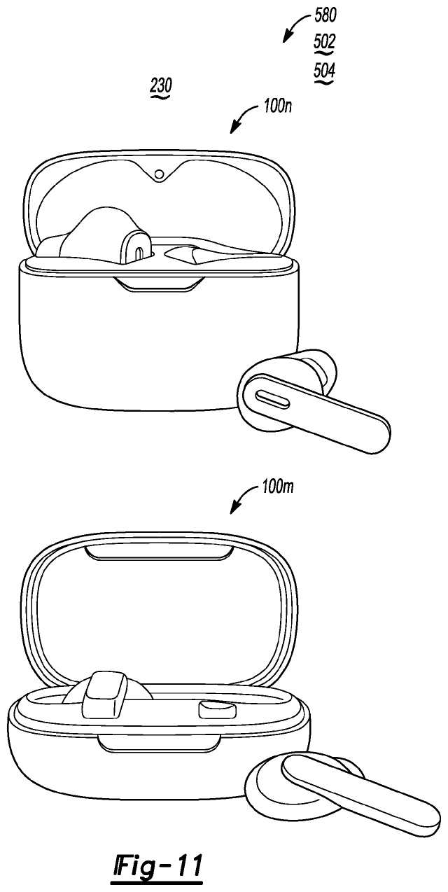

FIG. 11 depicts another screen shot 580 illustrating recommended earbuds 100n and 100m to the user in accordance with one embodiment. Thus, in this regard, the systems 200 or 300 may use the captured images of the right and left ear to determine the recommended earbuds 100n and 100m that may provide optimal fit and comfort for the earbud based on the anatomical features of the user's cars as captured on the images. The earbuds 100n-100m be presented in order of preference. In this example, the display 504 may indicate that the JBL TUNE 230NC® or the JBL LIVE PRO2® may provide the most optimal fit and comfort for the user. The systems 200 and/or 300 may aid the user in selecting the most optimal set of earbuds and thus avoid the condition in which a user may purchase earbuds and come to find that the purchased earbuds may not be compatible with the user's anatomical features of the ears and avoid the need to have to return the earbuds.

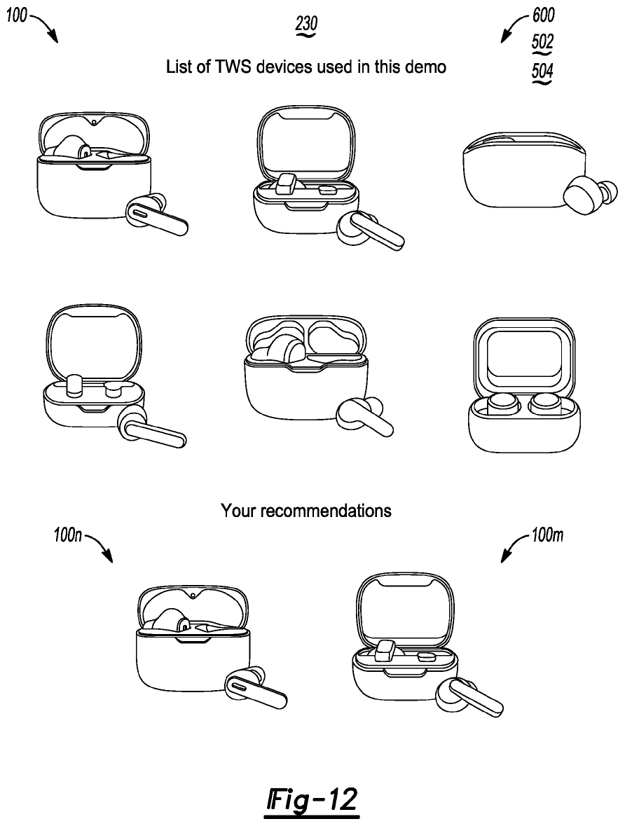

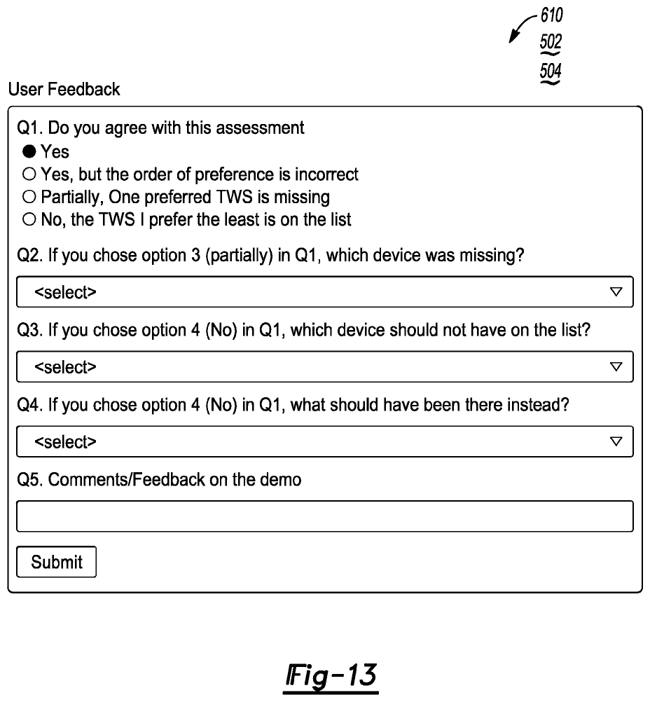

FIG. 12 depicts another screen shot 600 illustrating various earbuds 100 on the display 504 of the user interface 502 as assessed in connection with the user's ear measurements in accordance with one embodiment. In general, the memory device 232 may store any number of the earbuds 100 to assess compatibility or comfort of the earbuds based on the anatomical layout of the user's ears. It is recognized that the memory device 232 may be continuously or periodically updated with new earbuds via wireless communication with other electronic devices (e.g., servers, etc.). FIG. 13 depicts another screen shot 610 illustrating a user feedback screen on the display 504 of the user interface 502 in accordance with one embodiment. The screen shot 610 enables the user to respond to questions pertaining to earbud recommendation/assessment. For example, the user may respond to questions that ask whether the user agrees with the recommendation, whether the order of preference is incorrect, if any one or more earbuds that may be preferred by the user is missing from the list, or, if the preferred earbud 100m-100n is not recommended in the screen shot 580.

In the event the user indicates that a particular earbud hasn't been considered by the system 200 or 300, the electronic device 201 may electrically communicate with an external server (not shown) and obtain information pertaining to the requested device and provide a recommendation once the corresponding information pertaining to the requested earbud has been obtained.

It is recognized that the controllers as disclosed herein may include various microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, such controllers as disclosed utilizes one or more microprocessors to execute a computer-program that is embodied in a non-transitory computer readable medium that is programmed to perform any number of the functions as disclosed. Further, the controller(s) as provided herein includes a housing and the various number of microprocessors, integrated circuits, and memory devices ((e.g., FLASH, random access memory (RAM), read only memory (ROM), electrically programmable read only memory (EPROM), electrically erasable programmable read only memory (EEPROM)) positioned within the housing. The controller(s) as disclosed also include hardware-based inputs and outputs for receiving and transmitting data, respectively from and to other hardware-based devices as discussed herein.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for predicting a user's fit preference for an in-ear headphone, the system comprising:
an image detection device programmed to capture at least one image of at least a user's ear;
at least one controller programmed to:
detect one or more anatomical features on the least one image of the at least one user's ear; and
provide at least one selected in-ear headphone to the user based at least on the one or more anatomical features.

2. The system of claim 1, wherein the at least one controller is further programmed to provide at least one selected in-ear headphone to the user based at least on the one or more anatomical features utilizing a machine learning algorithm.

3. The system of claim 2, wherein the at least one controller is further programmed to position a bounding box around a first image of a user's right ear and a second image of a user's left ear.

4. The system of claim 3, wherein the at least one controller is further programmed to crop portions of the first image and the second image that are outside of the bounding box to reduce a processing load for the at least one controller.

5. The system of claim 3, wherein the bounding box corresponds to coordinates of a rectangular border that encloses the first image of the user's right ear and the second image of the user's left ear.

6. The system of claim 4, wherein the at least one controller is further programmed to monitor an aspect ratio of the bounding box positioned around the first image of the user's right ear and the bounding box positioned around the second image of the user's left ear and the user's left ear to determine a reliability of the first image and the second image.

7. The system of claim 6, wherein the at least one controller is further programmed to perform image normalization on a least the first image of the user's right ear and on at least the second image of the user's left ear to compensate for at least one of noise, lighting, and artifacts that are present in the bounding box of the user's right ear and the bounding box of the user's left ear.

8. The system of claim 3, wherein the at least one controller is further programmed to detect one or more of a helix, a superior cris, a triangular fossa, an inferior crus, a concha cymba, a tragus, an external auditory canal, a concha cavum, a lobule, an antitragus, an antihelix, and a scaphoid fossa of the at least one user's ear and to provide an output indicative of a recommendation for the at least one selected in-ear headphone to the user after positioning the bounding box around the first image of the user's right ear and the second image of the user's left ear.

9. The system of claim 1, wherein the image detection device and the at least one controller are implemented on one of a mobile device, a laptop, and a tablet.

10. A method for predicting a user's fit preference for an in-ear headphone, the method comprising:
receiving at least one image of a user's ear;
detecting one or more anatomical features on the least one image of the user's ear; and
providing at least one selected in-ear headphone to the user based at least on the one or more anatomical features.

11. The method of claim 10, wherein providing that at least one selected in-ear headphone to the user based at least on the one or more anatomical features includes providing that at least one selected in-ear headphone to the user based at least on the one or more anatomical features utilizing a machine learning algorithm.

12. The method of claim 11 further comprising positioning a bounding box around a first image of a user's right ear and a second image of a user's left ear.

13. The method of claim 12 further comprising cropping portions of the first image and the second image that are outside of the bounding box to reduce a processing load for at least one controller.

14. The method of claim 13, wherein the bounding box corresponds to coordinates of a rectangular border that encloses the first image of the user's right ear and the second image of the user's left ear.

15. The method of claim 13 further comprising monitoring an aspect ratio of the bounding box positioned around the first image of the user's right ear and the bounding box positioned around the second image of the user's left ear and the user's left ear to determine a reliability of the first image and the second image.

16. The method of claim 15 further comprising performing image normalization on a least the first image of the user's right ear and on at least the second image of the user's left car to compensate for at least one of noise, lighting, and artifacts that are present in the bounding box of the user's right ear and the bounding box of the user's left ear.

17. The method of claim 13 further comprising detecting one or more of a helix, a superior cris, a triangular fossa, an inferior crus, a concha cymba, a tragus, an external auditory canal, a concha cavum, a lobule, an antitragus, an antihelix, and a scaphoid fossa of the at least one user's ear of the one and to provide an output indicative of a recommendation for the at least one selected in-ear headphone to the user after positioning the bounding box around the first image of the user's right ear and the second image of the user's left ear.

18. A computer-program product embodied in a non-transitory computer read-able medium that is stored in memory and is executable by at least one controller to predict a user's fit preference for an in-ear headphone, the computer-program product comprising instructions for:
receiving at least one image of a user's ear;
detecting one or more anatomical features on the least one image of the user's ear; and
providing at least one selected in-ear headphone to the user based at least on the one or more anatomical features.

19. The computer program product of claim 18, wherein providing that at least one selected in-ear headphone to the user based at least on the one or more anatomical features includes providing that at least one selected in-ear headphone to the user based at least on the one or more anatomical features utilizing a machine learning algorithm.

20. The computer program product of claim 18 further comprising positioning a bounding box around a first image of a user's right ear and a second image of a user's left ear.
